(19) United States
(12) Patent Application Publication
(10) Pub. No.: US 2007/0067191 A1
(43) Pub. Date: Mar. 22, 2007

(54) Claim adjustment quality review

(76) Inventor: James E. Loveland, Alpine, UT (US)

Correspondence Address: KIRTON & McCONKIE, Suite 1800, 60 East South Temple, Salt Lake City, UT, 84111, US

(21) Appl. No.: 11/232,695

(22) Filed: Sep. 22, 2005

(51) Int. Cl. G06Q 40/00

(52) U.S. Cl. 705/4

(57) ABSTRACT

The present invention relates to a financial reinspection system that allows for efficient identification of financial issues regarding claim disbursements. One embodiment of the present invention is a database system in which all claims are tracked. Each tracked claim includes a plurality of characteristics or data items such as the identity of the claim adjuster, the identity of an assigned contractor, the location of the claim, the total claim amount, etc. The claims can be searched and sorted according to any one of the data items such that patterns or potential problems can easily be identified in an efficient manner. In addition, the system includes the ability to set rules which can be used to perform particular searches automatically in real time. The results generated from the rules can then be used to further identify financial problems. The specific process utilized by the system embodiment includes analyzing data items, formulating and processing rules in real time, and implementing reinspections based on the results generated by the rules. The analysis of data items includes identifying particular data items or combinations of data items which may be more likely to be associated with financial claim problems. The formulation and processing of rules in real time includes any type of real time search with one or more of the data items of the claims. And likewise, the implementation of reinspections includes any type of actions taken as a result of the information learned from the rule results.

### BACKGROUND

1. Field of the Invention

The present invention relates to a quality review system for claims adjustment. More particularly, the present invention relates to a financial reinspection system that allows for efficient identification of financial issues regarding claim disbursements.

2. Background of the Invention and Related Art

Insurance companies make payments on claims in response to various types of damage. These claims are based on assessments made by claim adjusters and estimates given by various types of contractors. In particular, property or home type insurance relates to claims made to non-automobile type property such as structures, personal property, etc. These claims can result from natural disasters, theft, unforeseen decomposition, etc. In certain circumstances, a claim adjuster may be sent to the site of a claim to make adjustments to the amount of money allocated.

In addition to conventional claim adjustment problems, various other financial claim issues can arise during the course of a claim. For example, a particular contractor may state that certain stages of a job are completed in order to receive additional money. Likewise, a claim adjuster could erroneously over value a claim forcing the insurance company to issue unnecessary money to the claimant. And further, a claim adjuster or contractor may be engaged in fraudulent behavior causing the overpayment of multiple claims.

Traditionally, claims were processed and reviewed on a monthly basis. The claims were organized and listed based on one set of criteria which may or may not allow for the discovery of many of the financial problems discussed above. Therefore, financial claim problems were unlikely to be discovered until after they have occurred for a substantial amount of time.

### SUMMARY OF THE INVENTION

The present invention relates to a financial reinspection system that allows for efficient identification of financial issues regarding claim disbursements. One embodiment of the present invention is a database system in which all claims are tracked. Each tracked claim includes a plurality of characteristics or data items such as the identity of the claim adjuster, the identity of an assigned contractor, the location of the claim, the total claim amount, etc. The claims can be searched and sorted according to any one of the data items such that patterns or potential problems can easily be identified in an efficient manner. In addition, the system includes the ability to set rules which can be used to perform particular searches automatically in real time. The results generated from the rules can then be used to further identify financial problems. The specific process utilized by the system embodiment includes analyzing data items, formulating and processing rules in real time, and implementing reinspections based on the results generated by the rules. The analysis of data items includes identifying particular data items or combinations of data items which may be more likely to be associated with financial claim problems. The formulation and processing of rules in real time includes any type of real time search with one or more of the data items of the claims. And likewise, the implementation of reinspections includes any type of actions taken as a result of the information learned from the rule results.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a suitable operating environment for the present invention;

FIG. 2 illustrates a schematic representation of a system in accordance with one embodiment of the present invention; and

FIG. 3 illustrates a flow chart of a method in accordance with one embodiment of the present invention.

### DETAILED DESCRIPTION OF THE PREFERRED EMBODIMENTS

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The present invention relates to a financial reinspection system that allows for efficient identification of financial issues regarding claim disbursements. One embodiment of the present invention is a database system in which all claims are tracked. Each tracked claim includes a plurality of characteristics or data items such as the identity of the claim adjuster, the identity of an assigned contractor, the location of the claim, the total claim amount, etc. The claims can be searched and sorted according to any one of the data items such that patterns or potential problems can easily be identified in an efficient manner. In addition, the system includes the ability to set rules which can be used to perform particular searches automatically in real time. The results generated from the rules can then be used to further identify financial problems. The specific process utilized by the system embodiment includes analyzing data items, formulating and processing rules in real time, and implementing reinspections based on the results generated by the rules. The analysis of data items includes identifying particular data items or combinations of data items which may be more likely to be associated with financial claim problems. The formulation and processing of rules in real time includes any type of real time search with one or more of the data items of the claims. And likewise, the implementation of reinspections includes any type of actions taken as a result of the information learned from the rule results. While embodiments of the present invention are directed at a financial reinspection system that allows for efficient identification of financial issues regarding claim disbursements, it will be appreciated that the teachings of the present invention are applicable to other areas.

As used in this specification, the following terms are defined accordingly:

“claims”—refers to any type of incident in which an insurance company must pay out money as a result of an insurance policy (a demand for payment in accordance with an insurance policy). Claims include lost property due to theft, damage resulting from natural disaster, damage resulting from vandalism, etc.

“data item”—refers to any type of characteristic associated with a claim including but not limited to identity of contractor, experience of contractor, location of claim, amount of the claim, type of claim, event which caused claim, financial institution, identity of claim adjuster, experience of claim adjuster, identity of claimant, and credit rating of claimant.

“real time”—refers to substantially instant results. For example, a subset of claims can be identified as a result of a rule in real time.

“rule”—refers to any criteria which can be used to create a subset of claims. Generally, the rules are based on various combinations and permutations of the data items associated with the claims.

“claim review”—refers to any type of subsequent analysis of a claim identified through the use of a rule.

“financial audit”—refers to any type of subsequent financial analysis of a claim in response to the identification of a claim with a rule.

The following disclosure of the present invention is grouped into two subheadings, namely “Exemplary Operating Environment” and “Quality Review System”. The utilization of the subheadings is for convenience of the reader only and is not to be construed as limiting in any sense.

### Exemplary Operating Environment

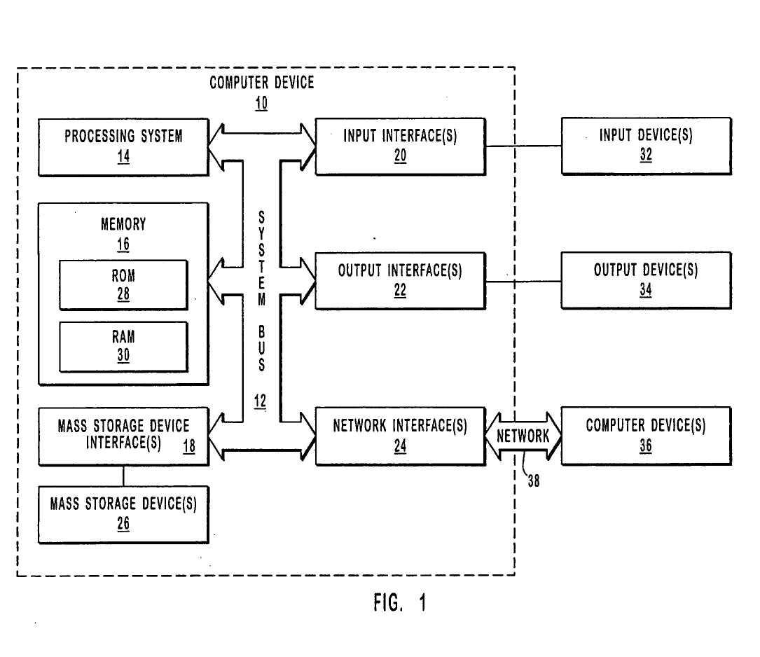

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration. Alternatively, the invention may also be practiced in whole or in part manually following the same procedures. Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below. Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

### Quality Review System

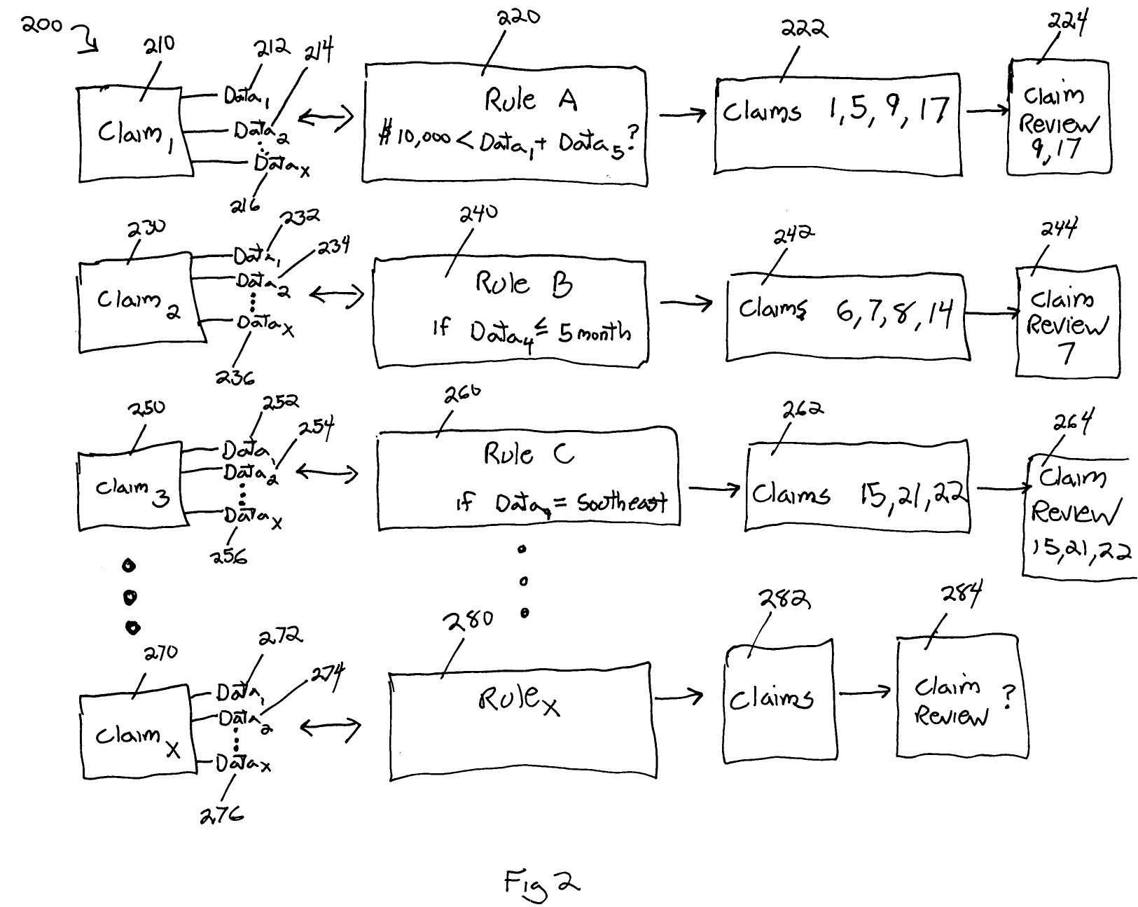

Reference is next made to FIG. 2, which illustrates a schematic representation of a system in accordance with one embodiment of the present invention, designated generally at 200. The system 200 generally includes a plurality of claims 210, 230, 250, 270. The claims represent individual events or circumstances which result in the payout of money from an insurance company to a claimant. Although the individual claims may involve multiple items of property damage, they each generally arise from the same incident. Each of the claims has an associated set of unlimited data items 212, 214, 216, 232, 234, 236, 252, 254, 256, 272, 274, 276. The data items describe various characteristics about the claims. For example, the identity of the contractor assigned to the claim, the experience level of the assigned contractor, the location of the claim, the type of claim, the amount of the claim, the event which caused the claim, the financial institution providing underwriting, the identity of the claim adjuster, the experience level of the claim adjuster, the identity of the claimant, and the credit rating of the claimant. The data items are correlated with particular claims as illustrated in the figure. Likewise, the data items of each claim are assigned corresponding positions such that claims can be compared with one another. For example, data item 3 for all claims may be a alphanumeric string corresponding to the geographic location of a claim. This way the claims could be sorted by their geographic location if a user wished to analyze geographic trends. The data items may contain any form of data corresponding to a claim.

The rules 220, 240, 260, 280 perform searches on the data items 212, 214, 216, 232, 234, 236, 252, 254, 256, 272, 274, 276 associated with the claims 210, 230, 250, 270 that produce resulting groups of claims 222, 242, 262, 282. Each rule may execute a different type of search such that a different subset of claims is created. The rules may be formulated manually or automatically to identify claims in which a potential financial problem may occur. For example, if the claim amount is over 10,000 dollars, there is a higher probability that someone may attempt some form of fraud with the claim. A specific rule could be formulated that identifies a set of resulting claims in which the claim value is over $10,000. Likewise, if the contractor or claim adjuster involved with a claim has less than a certain amount of experience, a specific rule could be formulated that identifies claims consistent with this criteria. And further, a rule could be formulated that identifies a resulting set of claims that are located in a particular geographic region.

The resulting claim sets 222, 242, 262, 282 can then be used to provide claims in which a claim review is more likely to be needed. It may be programmed that all of the claims in a resulting claim set should be scheduled for claim review or it may be programmed to randomly select a certain percentage of the resulting claims for a claim review. A claim review 224, 244, 264, 284 is any type of subsequent financial analysis of a claim. This may include sending a claim adjuster to the claim site to perform a financial audit or simply accessing a different set of data to review financial information regarding the claim. It is extremely important to identify claim related financial problems as soon as possible such that they do not reoccur and result in further loss of money. There are numerous types of financial problems that may result in claims that can be identified with a claim review. The term “liberal adjusters” refers to claims adjusters who overvalue claims either by accident or through inexperience. It is important to identify these adjusters as soon as possible so that they can be retrained for all subsequent claim adjusting assignments. Likewise, contractors may over estimate the completion of certain portions of their job which results in them being paid ahead of schedule and potentially not completing the job. Various other forms of fraud, mistakes, inexperience, and inconsistencies also may be considered claim related financial problems.

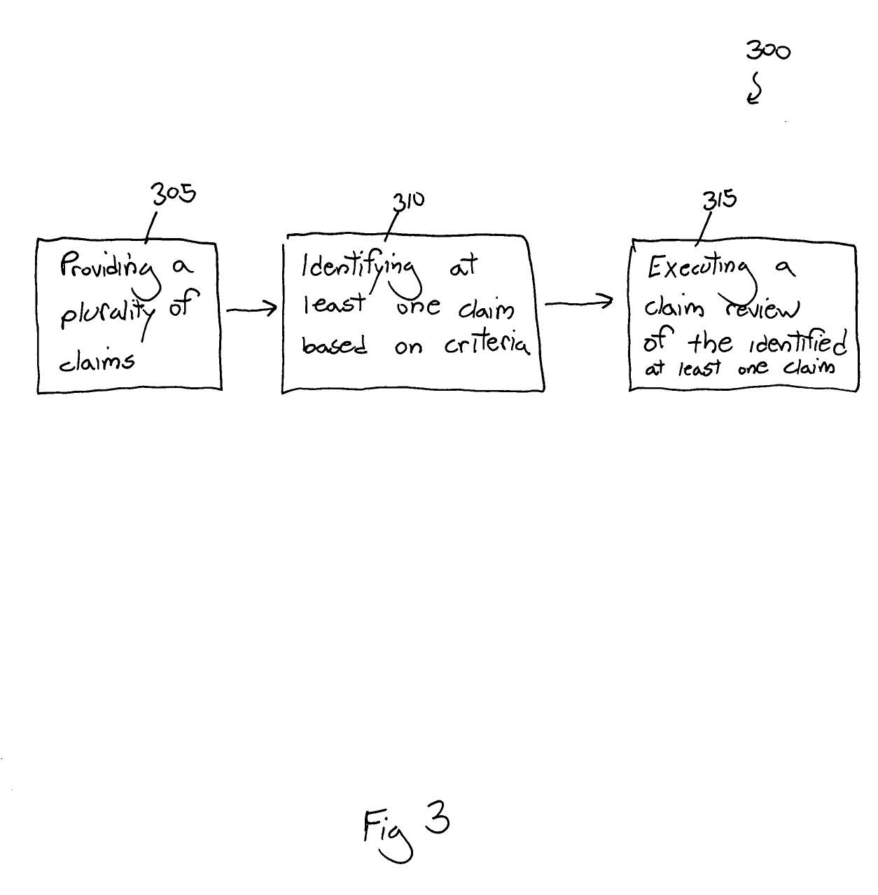

Reference is next made to FIG. 3, which illustrates a flow chart of a method in accordance with one embodiment of the present invention, designated generally at 300. A plurality of claims is initially provided, act 305. As described above, the provided claims may included associated crossreferenceable data items which describe various features of the claims. At least one claim is then identified based on a particular criteria, act 310. This act of identifying at least one claim is analogous to the execution of rules described above with reference to FIG. 2. The at least one claim is any subset of the provided claims that meet the criteria. The criteria may be any type of analysis of the claim or associated claim characteristics such as identifying claims which are valued over $10,000. The act of identifying at least one claim may be repeated to identify different sets of claims which meet other criteria. The criteria may be selected to identify claims which have a higher probability of being associated with some form of financial problem. The act of identifying may also be performed in real time to improve the response time in correcting financial problems. A claim review is then executed on the at least one claim, act 315. The claim review can be performed on all or a portion of the identified claims from act 310. The claim review involves any type of subsequent financial analysis of the claim in order to determine if a financial problem exists.

Thus, as discussed herein, the embodiments of the present invention relate to a quality review system for claims adjustment. More particularly, the present invention relates to a financial reinspection system that allows for efficient identification of financial issues regarding claim disbursements. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed and desired to be secured by Letters Patent is:

1. A system for quality review analysis of claims, comprising:
a claim which includes an associated data item;
a real time rule which identifies the claim according to a particular criteria based on a data item of the claim; and
a claim review performed on the claim.

2. The system of claim 1, wherein the data item consists of: the identity of contractor, experience of contractor, location of claim, type of claim, amount of the claim, event which caused claim, financial institution, identity of claim adjuster, experience of claim adjuster, identity of claimant, and credit rating of claimant.

3. The system of claim 1 further comprising a display of claims and associated data items.

4. The system of claim 1, wherein the plurality of claims can be organized and displayed according to any one or more of the associated data items.

5. The system of claim 1, wherein the real time rule is performed automatically at a particular interval and the identified claim is displayed.

6. The system of claim 1 further including a rule generation module which allows users to generate additional real time rules in response to particular circumstances.

7. The system of claim 1, wherein the claim review includes sending a financial reinspector out to the claim site to perform a financial audit.

8. A system for quality review analysis of claims, comprising:
a plurality of claims, wherein each claim includes at least one associated data item;
at least one real time rule which identifies at least one of the plurality of claims according to a particular criteria based on the associated at least one data items of each claim;
at least one display of the identified at least one claims;
a rule making module configured to allow a user to generate additional real time rules; and
a claim review performed on any one of the identified at least one claims.

9. A method of reviewing claims, comprising the acts of:
providing a plurality of claims, wherein each claim includes at least one associated data item;
identifying at least one claim of the plurality of claims in real time according to a particular criteria based on the associated at least one data items of each claim; and
executing a claim review on the identified at least one claim.

10. The method of claim 9, wherein the at least one associated data items include at least one of the identity of contractor, experience of contractor, location of claim, type of claim, event which caused claim, financial institution, identity of claim adjuster, experience of claim adjuster, identity of claimant, and credit rating of claimant.

11. The method of claim 9 further including displaying of each of the plurality of claims and the associated at least one data items.

12. The method of claim 9, wherein the plurality of claims can be organized and displayed according to any one or more of the associated data items.

13. The method of claim 9, wherein the at least one real time rule is performed automatically at a particular interval and the identified claims are displayed.

14. The method of claim 9 further including receiving at least one customized rule from a user that specifies alternative criteria for identifying at least one of the plurality of claims using the associated at least one data items.

15. The method of claim 9, wherein the claim review includes sending a financial reinspector out to the claim site to perform a financial audit.
